(19) United States
(12) Patent Application Publication
(10) Pub. No.: US 2004/0066033 A1
(43) Pub. Date: Apr. 8, 2004

(54) Hose assembly and method for making the same

(75) Inventors: Scott D. Rier, Ann Arbor, MI (US); Frederick W. Woodward, Dexter, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Pilot Industries, Inc., Dexter, MI

(21) Appl. No.: 10/267,064

(22) Filed: Oct. 8, 2002

(51) Int. Cl. F16L 55/00

(52) U.S. Cl. 285/23; 285/252

(57) ABSTRACT

A hose assembly having a resilient hose constructed of an elastomeric material. A hose clamp is positioned over one end of the hose. This hose clamp is then secured to the tube by applying a molten thermoplastic material over a portion of the hose as well as a portion of the hose clamp. The hose assembly thus achieves accurate positioning of the hose clamp on the hose prior to installation of the hose assembly in its intended application.

### BACKGROUND OF THE INVENTION

I. Field of the Invention

The present invention provides both a method and apparatus for attaching a hose clamp to an elastomeric hose.

II. Description of Related Art

There are many different applications, especially in the automotive industry, where a resilient hose is secured to a fluid fitting by a hose clamp which extends around the outside of the tube. With the tube then positioned over its fitting, tightening of the hose clamp compresses and sealingly secures the hose to the fitting.

In many applications, and particularly automotive applications, it is necessary that the hose clamp be properly positioned around the hose prior to tightening the hose clamp and securing the hose to the fitting. Otherwise, a fluid tight seal may not be obtained between the hose and its fitting. Furthermore, in view of increasingly stringent governmental regulations relating to the emissions of hydrocarbon vapors, an improperly secured hose in the fuel system of an automotive vehicle may render the vehicle noncompliant with government standards.

There have, however, been several previously known hose and hose clamp assemblies in which the hose clamp is attached to the hose in order to properly position the hose clamp on the hose prior to attachment of the hose to its fitting. These previously known hose and hose clamp assemblies, however, have proven expensive in manufacturing costs thus increasing the overall cost of the hose and hose clamp assembly.

Furthermore, many of these previously known methods have utilized an adhesive or other chemical bond to secure the hose clamp to the hose. As such, a relatively long curing and post-curing time is required in order to complete the hose-hose clamp assembly. Additionally, with these previously known adhesively bonded clamps, removal of the clamp cannot be effected without damaging the hose.

A still further disadvantage of these previously known hose assemblies is that many such assemblies encompass the entire hose and compress the entire hose prior to its final assembly. As such, these previously known hose-hose clamp assemblies undesirably increase the insertion force of the hose during its final assembly.

### SUMMARY OF THE PRESENT INVENTION

The present invention provides a hose and hose clamp assembly which overcomes all of the above-mentioned disadvantages of the previously known devices.

In brief, the hose and hose clamp assembly of the present invention comprise a hose constructed of an elastomeric material. A portion of the outer surface of the hose is first abraded in any conventional fashion, such as a wire wheel, adjacent its end where the hose is to be attached to a fitting in its final application.

After abrading the outer periphery of the hose, a hose clamp is slidably positioned over the end of the hose so that the hose clamp overlies the abraded portion of the hose.

A molten thermoplastic material is then applied under pressure across a portion of the clamp and the abraded portion of the hose. Consequently, upon cooling, the thermoplastic material hardens thus securing the clamp to the hose.

The molten thermoplastic material may be applied to the clamp and hose in several different ways. However, in a preferred embodiment, the hose and hose clamp are positioned within the mold which positions the hose clamp at the desired position on the hose for its final application. The mold also includes a mold chamber which overlies a portion of both the hose clamp as well as a portion of the abraded portion of the hose.

A mandrel is then inserted within the interior of the hose so that the mandrel extends through the end of the hose as well as through the hose clamp. Thereafter, the thermoplastic material, such as polyethylene, is injected into the mold chamber so that the thermoplastic material overlies both a portion of the clamp as well as the abraded portion of the hose. As the thermoplastic material cools, it hardens thereby attaching the hose clamp to the hose at its desired position on the hose. Thereafter, the hose clamp and hose assembly is utilized in its conventional fashion, i.e. by insertion of the end of the hose over its fluid fitting and tightening the hose clamp. However, since the hose clamp is properly positioned on the hose, a fluid tight seal is ensured upon tightening of the hose clamp.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is an elevational exploded view illustrating a first step in constructing the hose and hose clamp assembly of the present invention;

FIG. 2 is a view similar to FIG. 1 but illustrating a second step;

FIG. 3 is a fragmentary sectional view illustrating a further step of the present invention;

FIG. 4 is an elevational view illustrating a completed hose and hose clamp assembly; and

FIG. 5 is a longitudinal sectional view illustrating the attachment of the hose clamp to the hose and enlarged for clarity.

### DETAILED DESCRIPTION OF A PREFERRED EMBODIMENT OF THE PRESENT INVENTION

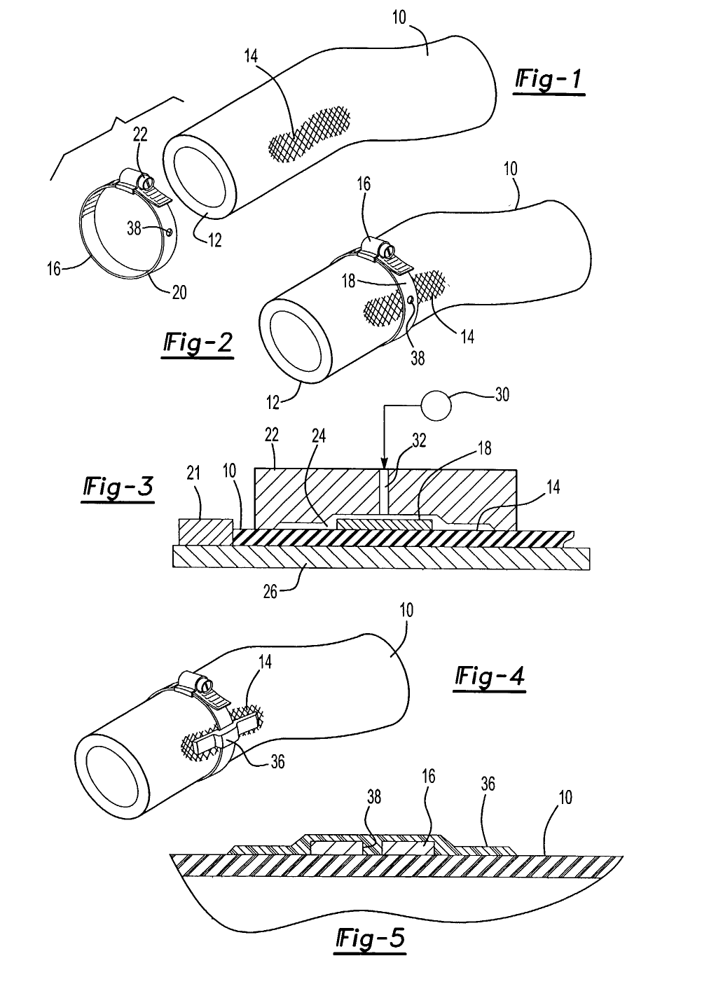

With reference first to FIG. 1, a portion of a hose 10 is illustrated of the type used in different applications, such as automotive applications. The hose 10 is constructed of a resilient material and is preferably constructed of an elastomeric material. One end 12 of the hose 10 is adapted for insertion over a fluid fitting or fluid coupling in the final application of the hose 10.

With reference now to FIGS. 1 and 2, a portion 14 of the outer periphery of the hose 10 is abraded. Any conventional means may be used to abrade the portion 14 of the hose 10. For example, a wire wheel, grinder or other means may be used to form the abraded portion 14 of the tube 10.

A hose clamp 16 is then slidably positioned over the end 12 of the hose 10 from the position shown in FIG. 1 and to the position shown in FIG. 2. As shown in FIG. 2, a portion 18 of the hose clamp 16 overlies the abraded portion 14 of the tube 10.

The hose clamp 16 illustrated in the drawing comprises a conventional hose clamp having an elongated metal strap 20 which is reduced in diameter by rotation of a tightening screw 22. In the well known fashion, the tightening screw 22 drives a worm gear which engages slots in the outer periphery of the strap 20. Thus, upon rotation of the screw 22, the diameter of the clamp 16 becomes smaller thus compressing the resilient hose 10 inwardly in the final application of the hose and hose clamp assembly of the present invention. Other types of clamps, however, can be used without deviation from the spirit or scope of the present invention.

With reference now to FIG. 3, in order to attach the clamp 16 to the hose 10, a thermoplastic material at least partially molten is applied under pressure across a portion of the clamp 16 and abraded portion 14 of the hose 10. Upon cooling, the thermoplastic material hardens and forms a band 36 which bonds the clamp 16 to the hose 10.

A conventional thermoplastic material, such as high density polyethylene, may be used to form the band 36. Furthermore, the abraded portion 14 of the hose 10, together with the application of the thermoplastic material under pressure, enhances the adhesion of the thermoplastic material to the hose.

Many different methods may be used to apply the thermoplastic material to the hose. For example, a band of thermoplastic material can be applied to a hot plate which melts one side of the band. The molten side of the band can then be applied, preferably under pressure, to the hose 10 and across a portion of the clamp 16. Similarly, a strip of completely molten thermoplastic can be applied onto the hose 10 and across a portion of the clamp and then compressed against the hose 10 and clamp 16 by a stamp.

In still a further and preferred method, the band 36 is molded onto the hose 10 and clamp 16.

With reference now to FIG. 3, after the hose clamp 16 is slidably positioned over the end 12 of the hose 10, the hose clamp 16 and hose 10 are positioned within a mold 22 having a mold chamber 24. The mold chamber 24 overlies both the portion 18 of the hose clamp 16 as well as a portion of the abraded portion 14 on the hose 10. Furthermore, the mold 22 includes a suitable fixture 21 (illustrated diagrammatically) to properly position the hose clamp 16 on the hose 10 at a predetermined distance from the hose end 12 and transversely of the hose 10 once the hose 10 and clamp 16 are positioned within the mold 22.

Still referring to FIG. 3, in order to prevent collapse of the hose 10, a mandrel 26 is inserted within the interior of the hose 10. This mandrel 26 abuts against the interior of the tube 10 under the mold chamber 24 and is rigid with respect to the mold 22. Furthermore, a mandrel is preferably used regardless of the method of applying the thermoplastic material.

After the hose 10 and clamp 16 are positioned within the mold 22 and the mandrel 26 inserted within the interior of the hose 10, a molten thermoplastic material from a source 30 then fills the mold chamber 24. Preferably, the molten material from the source 30 comprises a plastic material, such as high density polyethylene, and is preferably injected into the mold chamber 24 by conventional means through a sprue 32.

With reference now to FIGS. 4 and 5, as the thermoplastic material from the source 30 cools, it rigidities and the mold 22 is removed. In doing so, the thermoplastic material forms the band 36 which overlies the portion 18 of the clamp 16 as well as a portion of the abraded portion 14 of the hose 10 thereby securing the clamp 16 to the hose 10.

With reference now to FIGS. 2 and 5, in order to prevent the hose clamp 16 from rotating relative to the hose, the hose clamp 16 preferably includes an opening 38 in the portion 18 of the hose clamp 16. Thus, as the thermoplastic material is applied to the hose 10 and clamp 16, a portion of the thermoplastic material flows through the clamp opening 38 thus locking the clamp 16 against rotation relative to the hose 10.

In practice, the roughened portion 14 of the hose 10 provides for good adhesion between the heat curing material and the hose 10. Furthermore, since the clamp 16 is accurately positioned relative to the hose 10 as the molten thermoplastic material is applied, accurate positioning of the clamp 16 on the hose 10 in preparation for its final assembly is ensured.

From the foregoing, it can be seen that the present invention provides a simple, inexpensive and yet effective means for attaching a hose clamp to a hose in preparation for the final assembly of the hose-hose clamp assembly.

There are several advantages to the present invention. The material cost of the thermoplastic material is very low as compared to other bonding methods. Furthermore, the present invention does not require chemical curing but rather only cooling in order to form the bond between the heat curing material and the hose. This, in turn, results in faster cycle times than previously known methods. Furthermore, no post-cure period is required as with other known adhesive methods.

Additionally, the present invention is advantageous in that, if desired, the clamp can be removed by reheating and remelting the thermoplastic material with a heat gun or other means without damaging the hose. Previously known adhesive and elastomeric methods do not permit removal of the clamp without damaging the hose.

Additionally, the insertion force of the hose-hose clamp assembly is not affected by the present invention.

Having described my invention, however, many modifications thereto will become apparent to those skilled in the art to which it pertains without deviation from the spirit of the invention as defined by the scope of the appended claims.

1. A method for attaching a hose clamp to a resilient hose comprising the steps of:
placing the hose clamp over the hose to form a hose-clamp assembly,
applying an at least partially molten thermoplastic material across a portion of both the hose and clamp, and
allowing the thermoplastic material to cool and harden.

2. The invention as defined in claim 1 and comprising the step of abrading a portion of an outer surface of the hose prior to said applying step.

3. The invention as defined in claim 1 and comprising the step of inserting a mandrel into the hose prior to said applying step.

4. The invention as defined in claim 3 and comprising the step of applying pressure to said thermoplastic material after said applying step and prior to said cooling step.

5. The invention as defined in claim 1 wherein the hose is an elastomeric hose.

6. The invention as defined in claim 1 wherein the thermoplastic material comprises polyethylene.

7. The invention as defined in claim 1 wherein said applying step comprises the step of placing the hose clamp assembly in a mold having a mold chamber which overlies the portion of both the hose and the clamp, and thereafter filling the mold chamber with the thermoplastic material.

8. The invention as defined in claim 7 wherein the mold chamber extends transversely over the portion of the clamp and overlies the hose on both sides of the clamp.

9. The invention as defined in claim 1 wherein said clamp portion includes a through hole.

10. A hose assembly comprising:
a resilient hose,
a hose clamp positioned over said hose,
said hose clamp being secured to said hose by applying a molten thermoplastic material over a portion of said hose and a portion of said hose clamp.

11. The invention as defined in claim 10 wherein said hose is made of an elastomeric material.

12. The invention as defined in claim 10 wherein said thermoplastic material comprises polyethylene.

13. The invention as defined in claim 10 wherein said hose portion is roughened.

14. The invention as defined in claim 10 wherein said portion of said hose clamp includes a through hole.
